(19) United States
(12) Patent Application Publication
(10) Pub. No.: US 2019/0318883 A1
(43) Pub. Date: Oct. 17, 2019

(54) Halogenated Lithium Ion-Based Energy Storage Device and Related Method

(71) Applicant: ALBEMARLE CORPORATION, Charlotte, NC (US)

(72) Inventor: Yinzhi Zhang, Charlotte, NC (US)

(21) Appl. No.: 16/344,140

(22) PCT Filed: Dec. 28, 2017
(86) PCT No.: PCT/US2017/068621

§ 371 Date: Apr. 23, 2019

Related U.S. Application Data
(60) Provisional application No. 62/439,560, filed on Dec. 28, 2016.

(51) Int. Cl. H01G 11/50; H01G 11/34; H01G 11/36; H01G 11/06; H01G 11/52; H01G 11/26; H01G 11/86; C01B 32/354; C01B 32/225; C01B 32/194

(52) U.S. Cl. CPC H01G 11/50; H01G 11/34; H01G 11/36; H01G 11/06; H01G 11/52; C01P 2006/40; H01G 11/86; C01B 32/354; C01B 32/225; C01B 32/194; C01B 2204/22; H01G 11/26

(57) ABSTRACT

An energy storage device having a cathode comprised of one or more layers that are comprised of a halogenated activated carbon, an anode comprised of one or more layers that are comprised of a halogenated graphene, and a lithium ion source. Related methods of forming a cathode or forming an energy storage device are further described.

### TECHNICAL FIELD

This invention is in the technical field of lithium ion-based energy storage devices.

### BACKGROUND

Information from the relevant technical field described in this background section may be related to or provide context for some aspects of the devices and/or techniques described herein and/or claimed below. This information is background facilitating a better understanding of that which is described elsewhere in this disclosure. Such background may include a discussion of “related” art, but this discussion in no way implies that it is also “prior” art. The related art may or may not be prior art. The discussion in this background section is to be read in this light, and not as admissions of prior art.

Energy storage devices such as lithium ion capacitors (LICs) are a type of energy storage device employing a hybrid design that provides both relatively higher output voltage and greater energy density when compared to conventional electric double-layer capacitors, coupled with relatively higher power density when compared to conventional lithium ion batteries. LICs are also safer to discharge than conventional lithium ion batteries. Such capacitors have anodes and cathodes which are fabricated with different materials, the anodes typically being fabricated with a current collector coated with one or more layers of, for example, a graphitic material which maybe intercalated or pre-doped with a lithium source, the cathodes being typically fabricated with a current collector coated with one or more layers of, for example, a carbonaceous material such as, for example, activated carbon. The anodes also may be simply comprised of the graphitic material without the presence of a separate current collector in some designs. Various anode and cathode materials and designs exist, but significantly increased capacitance remains an elusive goal.

Thus, a need continues to exist for improvements in the energy storage and power output capacities of energy storage devices.

### SUMMARY OF THE INVENTION

This disclosure pertains to an invention that addresses this and other needs in a surprisingly effective way. In one aspect, the invention provides an energy storage device comprising a cathode (in this instance a positively charged electrode) which is comprised of one or more surface layers that are comprised of a halogenated activated carbon, an anode (in this instance a negatively charged electrode) which is comprised of one or more surface layers that are comprised of a halogenated graphene, and a lithium ion source. This device or cell may stand alone or be one of a plurality of cells arrayed in series, wound or stacked, for example, in a conventional manner to provide a high capacity energy storage device.

Another aspect of the invention provides a process for forming a cathode for use in an energy storage device. The process comprises forming the cathode so as to provide at least one cathode surface layer, the cathode surface layer being comprised of a gas-phase brominated activated carbon. In some particular aspects of the invention, the amount of bromine in the gas-phase brominated activated carbon is in the range of about 0.1 wt. % to about 15 wt. %, based on the weight of the total brominated activated carbon.

In still another aspect of the invention, there is provided a process for producing an energy storage device. This process comprises carrying out the process above for forming a cathode, forming an anode so as to provide at least one anode surface layer, the anode surface layer being comprised of a halogenated graphene, providing a lithium ion source either in or adjacent to the anode, and disposing the anode and the cathode adjacent one another with a conductive medium there between, so as to form an energy storage device. It should be understood that, as used herein, “adjacent” when describing the location of the lithium ion source relative to the anode, means the lithium ion source is at least contained within an energy storage device housing that encapsulates the anode, the cathode and the conductive medium and is in sufficiently close proximity to the anode that the source electrochemically contributes lithium ions during use of the device.

Yet another aspect of the invention provides an energy storage device comprising a first electrode, a second electrode, a lithium ion source and a conductive medium disposed between the first and the second electrodes, one of the electrodes being comprised of at least one surface layer, wherein the surface layer is comprised of a gas-phase brominated activated carbon. In particular aspects of the invention, the amount of bromine in the gas-phase brominated activated carbon is in the range of about 0.1 to about 15 wt. %, based on the weight of the total brominated activated carbon.

In some aspects of the invention, the halogenated activated carbon is a gas-phase brominated activated carbon. In some aspects of the invention, the halogenated graphene comprises a brominated graphene. In still other aspects of the invention, the brominated graphene is comprised of brominated graphene nanoplatelets. The brominated graphene nanoplatelets in still other aspects of the invention comprise one or more graphene layers and are characterized by being, except for the carbon atoms forming the perimeters of the graphene layers of the nanoplatelets, (i) free from any element or component other than sp2 carbon, and (ii) substantially defect-free graphene layers, wherein the total content of halogen in the nanoplatelets is about 5 wt % or less calculated as bromine and based on the total weight of the nanoplatelets.

These and other aspects and features of this invention will be still further apparent from the ensuing description, drawings and appended claims.

### BRIEF DESCRIPTION OF THE DRAWINGS

FIG. 1 is a set of cyclic voltammetry (CV) curves for a cathode of a lithium ion capacitor in accordance with one embodiment of the invention described in Example 1, wherein the cathode has a surface coated with a gas phase-brominated powder activated carbon, and a comparative cathode described in Comparative Example 2 having a surface coated with a powder activated carbon which was not brominated.

FIG. 2A is a set of CV curves for a cathode of a lithium ion capacitor in accordance with one embodiment of the invention described in Example 3, the cathode having a surface coated with a gas phase-brominated powder activated carbon, taken at three different scan rates (20, 50, and 100 mV/s).

FIG. 2B is a set of CV curves for a cathode of a comparative lithium ion capacitor made in Comparative Example 4, the cathode having a surface coated with a powder activated carbon not previously brominated, taken at three different scan rates (20, 50, and 100 mV/s).

FIG. 3 is a set of CV curves for an anode in accord with one aspect of the invention described in Example 5, the anode having a surface coated with brominated graphene nanoplatelets and a comparative anode described in Comparative Example 6 having a surface coated with commercially available graphite.

FIG. 4 is a set of CV curves for two different lithium ion capacitors, one lithium ion capacitor being in accord with one aspect of the invention described in Example 7, where the cathode has a surface coated with brominated powdered activated carbon, the other lithium ion capacitor being as described in Comparative Example 8 and having a comparative cathode with a surface coated with a powdered activated carbon not previously brominated, wherein the anode in each of the capacitors has a surface coated with commercially available graphite which has been prelithiated.

FIG. 5 is a bar graph comparing the determined capacitance values for various cathodes described in Example 9 and Example 9A.

FIG. 6 is bar graph comparing the determined capacitance values for various cathodes described in Example 10, together with those in Example 9 and Example 9A.

FIG. 7 is a cross-sectional view of a lithium ion capacitor in accordance with one aspect of the invention.

Where applicable, like reference numbers or other symbols present in the figures are used to refer to like parts or components illustrated amongst the several figures.

### DETAILED DESCRIPTION OF THE INVENTION

Illustrative aspects of the subject matter claimed below will now be disclosed. In the interest of clarity, not all features of an actual implementation are described in this specification. It will be appreciated that in the development of any such actual implementation, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The aspects illustrated herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components or steps. Further, various ranges and/or numerical limitations may be expressly stated herein, and it should be recognized that unless stated otherwise, it is intended that endpoints are to be interchangeable. Further, any ranges include iterative ranges of like magnitude falling within the expressly stated ranges or limitations disclosed herein and they are to be understood to set forth every number and range encompassed within the broader range of values. It is to be noted that the terms “range” and “ranging” as used herein generally refer to a value within a specified range and encompass all values within that entire specified range, inclusive of the end points of such range.

As used throughout this document, “energy storage device” means a rechargeable electrochemical device comprised of at least two electrodes and a conductive medium disposed between the electrodes. Likewise, the term “lithium ion source” means a lithium ion per se or a composition of matter which may undergo a reaction or transformation to form a lithium ion per se. The term “activated carbon” means a particulate activated carbon and “gas phase-brominated activated carbon” means a particulate activated carbon brominated with a bromine-containing gas. The term “conductive medium” means a conducting medium in which the flow of current is accompanied by the movement of matter in the form of ions. All other terms used in this disclosure not otherwise specifically defined shall have their normal and customary meaning to a person having ordinary skill in the relevant technical field as of the earliest effective filing date of this disclosure.

### The Anode

The negative electrode (anode) of the energy storage device of the invention will typically be comprised of a current collector having at least one surface that is coated with one or more layers of a composition comprised of a halogenated graphene. The composition may further comprise a binder in admixture with the halogenated graphene. In some aspects of the invention, the composition further comprises one or more of:
at least one substance selected from carbon, silicon, and/or one more silicon oxides;
the binder;
a conductive aid; and/or
carbon black.

Non-limiting examples of suitable binders include fluoride-based resin such as polytetrafluoroethylene (PTFE), polyvinylidene fluoride (PVdF), and the like, thermosetting resin such as polyimide, polyamidoimide, polyethylene (PE), polypropylene (PP), and the like, cellulose-based resin such as carboximethyl cellulose (CMC), and the like, rubber-based resin such as stylenebutadiene rubber (SBR) and the like, ethylenepropylenediene monomer (EPDM), polydimethylsiloxane (PDMS) and polyvinyl pyrrolidone (PVP). Non-limiting examples of suitable conductive aids include Ketjenblack® carbon black, acetylene black, carbon fiber, or a composite material of the foregoing.

The anode may be fabricated in various ways. It is possible that the anode be comprised entirely of one or more halogenated graphene—comprising layers fabricated without the use of a current collector. But more typically the anode will have a current collector with one or more surfaces which is coated with a mixture comprised of halogenated graphene, a solvent and a binder, the mixture being applied as a liquid or paste to a current collector surface and allowed to dry so as to form at least one anode surface layer. The halogenated graphene in one aspect of the invention is a brominated graphene. In another aspect of the invention, the brominated graphene is brominated graphene nanoplatelets. The solvent employed is not limited and is, for example, a polyvinyl alcohol aqueous solution serving as a thickener or an aqueous solvent binder such as a fluororesin dispersion, polytetrafluoroethylene, polyvinyl alcohol, polyvinylidene fluoride or water. When polytetrafluoroethylene, polyvinyl alcohol, or the like is used as the binder, water may be used as the solvent. When an aqueous solvent is used, a neutral surfactant such as a polyether surfactant is preferably added in an amount of 0.1 to 0.5% by weight in order to enhance the filling capability into the current collector. In another usable example, polyvinylidene fluoride as a binder is dissolved in an organic solvent such as N-methyl-2-pyrrolidone, for example.

In one particular aspect of the invention, the graphene is in the form of graphene nanoplatelets. In another aspect of the invention, the graphene nanoplatelets are halogenated. The halogenated graphene nanoplatelets comprise graphene layers and are characterized by having, except for the carbon atoms forming the perimeters of the graphene layers of the nanoplatelets, (i) graphene layers that are free from any element or component other than sp2 carbon, and (ii) substantially defect-free graphene layers. The total content of halogen in the halogenated graphene nanoplatelets is about 5 wt % or less calculated as bromine and based on the total weight of the halogenated graphene nanoplatelets. In one aspect of the invention, there is an amount of about 0.1 wt % or more, or in the range of about 0.1 to about 98 wt. %, halogenated graphene nanoplatelets in the anode, based on the total weight of the anode active material. In such cases, the anode preferably comprises a binder. In another aspect of the invention, halogenated graphene nanoplatelets, preferably brominated graphene nanoplatelets, take the place of about 10 wt. % to about 100 wt. % of the conductive aid and/or carbon black, or take the place of about 1 wt. % or more of the carbon, silicon, and/or one more silicon oxides, in the anode.

The phrase “free from any element or component other than sp2 carbon” indicates that the impurities are usually at or below the parts per million (ppm; wt/wt) level, based on the total weight of the nanoplatelets. Typically, the halogenated graphene nanoplatelets have about 3 wt % or less oxygen, preferably about 1 wt %, or less oxygen; the oxygen observed in the halogenated graphene nanoplatelets is believed to be an impurity originating in the graphite starting material.

The phrase “substantially defect-free” indicates that the graphene layers of the halogenated graphene nanoplatelets are substantially free of structural defects including holes, five-membered rings, and seven-membered rings.

In some aspects of the invention, the halogenated graphene nanoplatelets comprise chemically-bound halogen at the perimeters of the graphene layers of the nanoplatelets. The halogen atoms that can be chemically-bound at the perimeters of the graphene layers of the halogenated graphene nanoplatelets include fluorine, chlorine, bromine, iodine, and mixtures thereof, bromine being preferred in at least some aspects of the invention.

While the total amount of halogen present in the nanoplatelets may vary, the total content of halogen in the nanoplatelets is about 5 wt. % or less, and is preferably in the range equivalent to a total bromine content (or calculated as bromine) in the range of about 0.001 wt. % to about 5 wt. % bromine, based on the total weight of the nanoplatelets, which is determined by the amounts and atomic weights of the particular diatomic halogen composition being used. More preferably, the total content of halogen in the nanoplatelets is in the range equivalent to a total bromine content in the range of about 0.01 wt. % to about 4 wt. % bromine based on the total weight of the nanoplatelets. In some embodiments, the total content of halogen in the nanoplatelets is preferably in the range equivalent to a total bromine content in the range of about 0.001 wt. % to about 5 wt. % bromine, more preferably about 0.01 wt. % to about 4 wt. % bromine, based on the total weight of the nanoplatelets.

As used throughout this document, the phrases “as bromine,” “reported as bromine,” “calculated as bromine,” and analogous phrases for the halogens refer to the amount of halogen, where the numerical value is calculated for bromine, unless otherwise noted. For example, elemental fluorine may be used, but the amount of halogen in the halogenated graphene nanoplatelets is stated as the value for bromine.

The halogenated graphene nanoplatelets may be formed in accordance with the process described in PCT Patent Appl. No. PCT/US2016/040369, the disclosure of which is incorporated herein by reference. Typically, the process involves:
I) contacting a diatomic halogen selected from elemental bromine (Br₂), elemental fluorine (F₂), iodine monochloride (ICl), iodine monobromide (IBr), iodine monofluoride (IF), and a mixture of any two or more of these, with graphite flakes to form solids comprising halogen-intercalated graphite; and
II) feeding, into a reaction zone free from oxygen and water vapor, the halogen-intercalated graphite while

(a) rapidly heating the halogen-intercalated graphite to, and maintaining the halogen-intercalated graphite at, a temperature of about 400° C. or above, and

(b) maintaining contact of a diatomic halogen selected from Br₂, F₂, ICl, IBr, IF, or a mixture of any two or more of these, with the halogen-intercalated graphite within said reaction zone; and

withdrawing halogenated exfoliated graphite from the reaction zone,

the halogenated exfoliated graphite having a total halogen content of about 5 wt % or less;
III) optionally repeating steps I) and II) in sequence one or more times;
IV) optionally subjecting said halogenated exfoliated graphite to a halogenated graphene nanoplatelet liberation procedure to form halogenated graphene nanoplatelets;
V) when step IV) is performed, optionally repeating steps I), II), and optionally IV) in sequence one or more times.

The graphite starting material in this production of halogenated graphene nanoplatelets is usually in the form of powder or, preferably, flakes. The particular form of the graphite (powder, flakes, etc.) and the source of the graphite (natural or synthetic) does not appear to affect the results obtained. The graphite has an average particle size of about 50 μm (˜270 standard U.S. mesh) or more. Preferably, the graphite has an average particle size of about 100 μm (˜140 standard U.S. mesh) or more. More preferably, the graphite has an average particle size of about 200 μm (70 standard U.S. mesh) or more, still more preferably about 250 μm (60 standard U.S. mesh) or more. It has been found that graphite with larger average particle sizes permit greater amounts of the diatomic halogen to be intercalated into the graphite, exfoliation occurs more easily, and products containing fewer layers of graphene are obtained (as compared to smaller-sized graphite flakes). It has also been found that graphite with average particle sizes of about 20 μm or less do not expand appreciably when subjected to the processes of this invention. Defects and/or impurities in the graphite starting material remain in the product halogenated exfoliated graphite and halogenated graphene nanoplatelets.

Expanded graphite is a commercially available product, and is the result of one set of intercalation and exfoliation steps, and may contain some oxygen from its production process. Commercially available expanded graphite can be used.

The halogenated graphene nanoplatelets so produced have high purity and little or no detectable chemically-bound oxygen impurities. Thus, the halogenated graphene nanoplatelets so obtained qualify for the description or classification of “pristine.” By “pristine or nearly pristine” as used herein, it is meant that either there is no observable damage, or if there is any damage to the graphene layers as shown by either high resolution transmission electron microscopy (TEM) or by atomic force microscopy (AFM), such damage is negligible, i.e., it is so insignificant as to be unworthy of consideration. For example, any such damage has no observable detrimental effect on the nanoelectronic properties of the halogenated graphene nanoplatelets. Generally, any damage in the halogenated graphene nanoplatelets originates from damage present in the graphite from which the halogenated graphene nanoplatelets are made; any damage and/or impurities from the graphite starting material remains in the product halogenated graphene nanoplatelets.

In addition, the halogenated graphene nanoplatelets are virtually free from any structural defects. This can be attributed at least in part to the pronounced uniformity and structural integrity of the sp2 graphene layers of the halogenated graphene nanoplatelets. Among additional advantageous features of these nanoplatelets are superior electrical conductivity and superior physical properties as compared to commercially available halogen-containing graphene nanoplatelets. Moreover, no solvents are required during the synthesis of the halogenated graphene nanoplatelets, nor is an intermediate step of forming a graphitic oxide needed to form the halogenated graphene nanoplatelets.

The diatomic halogen molecules for use in forming the halogenated graphene nanoplatelets of this invention generally include elemental bromine (Br₂), elemental fluorine (F₂), iodine monochloride (ICl), iodine monobromide (IBr), iodine monofluoride (IF), or a mixture of any two or more of these halogen compounds. Bromine (Br₂) is a preferred diatomic halogen molecule. The terms “diatomic halogen molecule” and “diatomic halogen” as used throughout this document include elemental halogen compounds and diatomic interhalogen compounds.

The term “halogenated” in halogenated graphene nanoplatelets, as used throughout this document, refers to graphene nanoplatelets in which Br₂, F₂, ICl, IBr, IF, or any combinations thereof were used in preparing the graphene nanoplatelets.

In one aspect of this invention, the halogenated, especially brominated, nanoplatelets comprise few-layered graphenes. By “few-layered graphenes” is meant that a grouping of a stacked layered graphene nanoplatelet contains up to about 10 graphene layers, preferably about 1 to about 5 graphene layers. Such few-layered graphenes typically have superior properties as compared to corresponding nanoplatelets composed of larger numbers of layers of graphene. Halogenated graphene nanoplatelets that comprise two-layered graphenes are particularly preferred, especially two-layered brominated graphene nanoplatelets.

Particularly preferred halogenated graphene nanoplatelets are brominated graphene nanoplatelets which comprise few-layered or two-layered brominated graphene nanoplatelets in which the distance between the layers is about 0.335 nm as determined by high resolution transmission electron microscopy (TEM). Brominated graphene nanoplatelets wherein said nanoplatelets comprise two-layered graphene in which the thickness of said two-layered is about 0.7 nm as determined by Atomic Force Microscopy (AFM) are also particularly preferred.

Moreover, the halogenated graphene nanoplatelets often have a lateral size as determined by Atomic Force Microscopy (AFM) in the range of about 0.1 to about 50 microns, preferably about 0.5 to about 50 microns, more preferably about 1 to about 40 microns. In some applications, a lateral size of about 1 to about 20 microns is preferred for the halogenated graphene nanoplatelets. For halogenated graphene nanoplatelets, larger lateral size often provides better conductivity and increased physical or mechanical strength. Lateral size is the linear size of the halogenated graphene nanoplatelets in a direction perpendicular to the layer thickness.

The halogenated graphene nanoplatelets, especially brominated graphene nanoplatelets, in particular aspects of this invention have enhanced dispersibility in water. It is theorized that this property is provided by the chemically-bound halogen at the perimeters of the graphene layers of the nanoplatelets.

Another advantageous feature of the halogenated graphene nanoplatelets in particular aspects of this invention, especially the brominated graphene nanoplatelets, is superior thermal stability. In particular, the brominated graphene nanoplatelets exhibit a negligible weight loss when subjected to thermogravimetric analysis (TGA) at temperatures up to about 800° C. under an inert atmosphere. At 900° C. under an inert atmosphere, the TGA weight loss of brominated graphene nanoplatelets is typically about 4 wt % or less, usually about 3 wt % or less. Further, the TGA weight loss temperatures of the brominated graphene nanoplatelets under an inert atmosphere have been observed to decrease as the amount of bromine increases. The inert atmosphere can be, e.g., helium, argon, or nitrogen; nitrogen is typically used and is often preferred.

### The Cathode

The positive electrode (cathode) of the energy storage device of the invention will typically be comprised of a current collector having at least one surface that is coated with one or more surface layers comprised of a halogenated activated carbon. The composition may further comprise a binder and/or one or more additives; a conductive aid and/or carbon black, as taught above for the anode, in admixture with the halogenated activated carbon.

The cathode may be fabricated in various ways. Typically, the cathode will have a current collector with one or more surfaces which is coated with a mixture comprised of halogenated activated carbon, a solvent and a binder, the mixture being applied as a liquid or paste to a current collector surface and allowed to dry so as to form at least one cathode surface layer.

The halogenated activated carbon is a halogenated particulate activated carbon, preferably a powdered activated carbon. Such powder may have various particular size attributes, but a typical average particle size is in the range of about 1 to about 100 μm, and a surface area of at least 100 m²/g. The halogenated, preferably brominated, activated carbon may be advantageously produced in accordance with the teachings of U.S. Pat. No. 6,953,494, the disclosure of which is incorporated herein by reference. Thus, for example, a brominated activated carbon may be brominated by exposing a quantity of dried, powder activated carbon in a suitable reactor or reaction zone to a bromine-containing gas such as gas phase Br₂ or another bromine-containing gas such as hydrogen bromide (HBr) gas. When the gas contacts the solids, it is quickly adsorbed and reacted with materials. In some instances, this is done at an elevated temperature (e.g., in the range of about 50 to about 250° C.), with the activated carbon being as hot as the bromine-containing gas, in another aspect of the invention, this contacting is done with the activated carbon at a temperature at or above about 150° C. The contacting of the bromine-containing gas and activated carbon can be carried out at any advantageous pressure, including atmospheric pressure. The process is carried out so as to achieve a halogenated activated carbon having in the range of about 0.02 to about 22 wt. % of halogen, based on the weight of the halogenated activated carbon. When bromine is the halogen, the amount of bromine in the gas-phase brominated activated carbon in one aspect of the invention is in the range of about 0.1 wt. % to about 15 wt. %, based on the weight of the total brominated activated carbon.

### Other Device Components

The current collectors of the respective anode and cathode when present may be comprised of the same or different materials respectively, but are typically comprised of different materials. The current collector of the anode when present is typically made, for example, of copper, nickel or stainless steel, in the form of a foil or mesh, while the current collector of the cathode when present is typically made, for example, of aluminum, stainless steel, copper, nickel, titanium, tantalum or niobium, in the form of a foil or mesh.

The conductive medium in accord with this invention will normally comprise a suitable electrolyte alone or with an aqueous or non-aqueous solvent. Suitable electrolytes will typically be lithium or ammonium salts. When a lithium salt is used, it will typically be selected from LiPF₆, LiBF₄ and LiClO₄, or the like, or solid electrolyte Li₆PS₅X (X═Cl, Br), or the like. The electrolyte can provide the medium for migration of lithium ions, and the lithium salt can also play a role as a supply source of the lithium ions during charging of the device.

When present, a separator disposed between the anode and the cathode may take any suitable form, but is typically a permeable, polymeric membrane, or a nonwoven, which consist of a manufactured sheet, web, or mat of directionally or randomly oriented fibers (e.g., paper), or a supported liquid membrane comprised of a solid and liquid phase contained within a microporous separator. In addition, polymer electrolytes which can form complexes with different types of alkali metal salts, to form ionic conductors which serve as solid electrolytes, may serve as a separator. Another type of separator, a solid ion conductor, can serve as both a separator and the electrolyte.

The lithium ion source in accord with this invention may be lithium ions per se, or a compound that may be transformed during use of the device to generate lithium ions. As noted above, in some aspects of the invention, the lithium ion source is an electrolyte. The lithium ion source, when not a component of the conductive medium itself, may be introduced to the device by various methods, including but not limited to a sacrificial strip of lithium metal, lithium powder pre-doped in either anode or cathode, or any prelithiated materials.

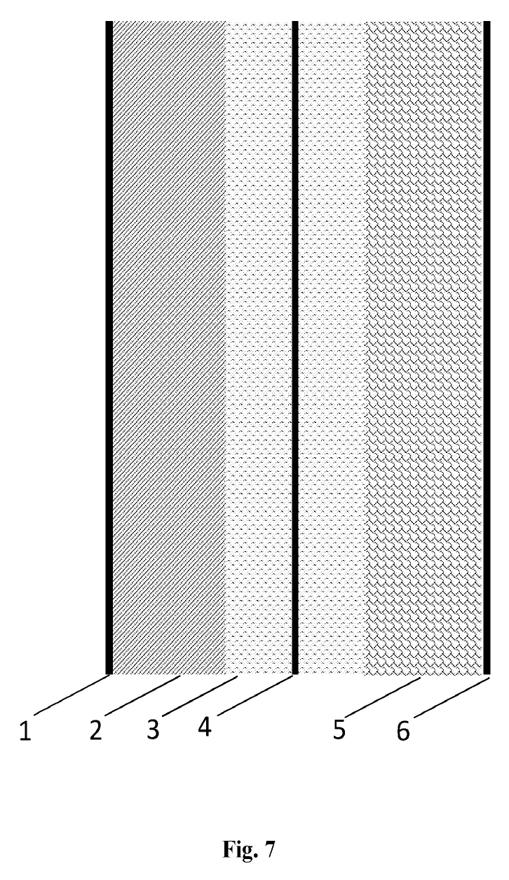

Referring now to the Figures, as mentioned above, FIG. 7 is a cross-sectional view of a lithium ion capacitor cell in accordance with one particular aspect of this invention. The illustrated capacitor cell includes an anode comprised of an anode current collector 1 and at least one anode surface layer 2, a cathode comprised of a current collector 6 and at least one cathode surface layer 5, a conductive medium 3 and a separator 4 disposed within medium 3 and between anode surface layer 2 and cathode layer 5. Variations of the illustrated design can be envisioned by those of ordinary skill in the art, having the benefit of this disclosure. For example, in addition, there may be a plurality of cells present in the device, arrayed, stacked or wrapped/rolled in series or in parallel, for example, in order to increase storage and output capacities. These cells typically will be contained within a housing (not depicted in the figure) that encapsulates the plurality of cells and provides positive and negative terminals associated with respective positive and negative electrodes from each of the cells. The housing typically is formed from a laminated film or a metallic substance. It should be appreciated that the accompanying FIG. 7 is not necessarily to scale, especially since the conductive medium 3 may itself be impregnated within separator 4 rather than forming separate layers around separator 4.

The following experimental Examples are presented for purposes of illustration, and are not intended to impose limitations on the scope of this invention.

### EXAMPLE 1

A commercially available powdered activated carbon (PAC) having a surface area of about 1300 m²/g was pre-dried at 120° C. and then exposed to gas-phase bromine of a predetermined amount according to the method of U.S. Pat. No. 6,953,494 to about 6 wt. % bromine in the resultant brominated. PAC (Br-PAC). The resultant Br-PAC (0.8 g) was mixed with binder (polyvinylidene fluoride; PVDF, 0.1 g) and conductive carbon black (0.1 g) in N-methylpyrrolidinone (NMP). The resultant paste was coated on an alumina foil using a Doctor Blade available for example from MTI Corporation of Richmond, Calif., from which multiple coin cells of about 2 cm diameter were assembled with lithium foil as a counter electrode and 1M of lithium hexafluorophosphate (LiPF₆) in ethylene carbonate/dimethyl carbonate (also referred to as “EC/DMC,” 1:1 ratio) as electrolyte.

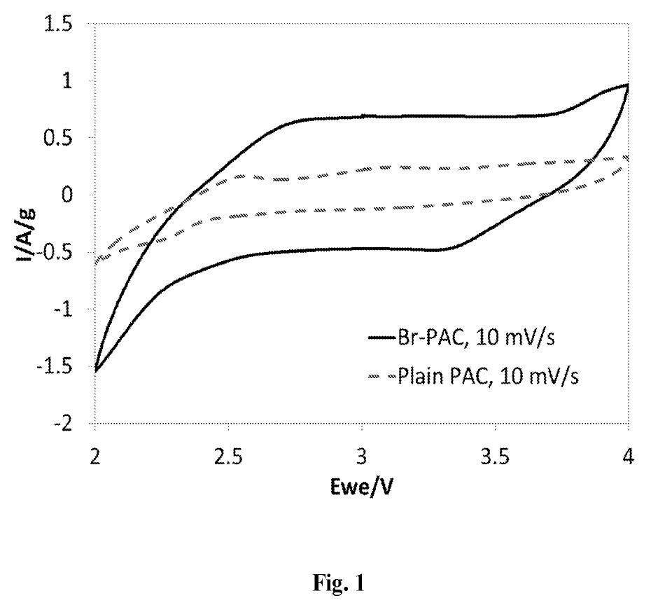

The cyclic voltammetry (CV) curves were measured with a potentiostat (model no. SP-150, Bio-Logic Science Instruments SAS, Claix, France) at 10 mV/s scan rate and repeated 5 times, and the capacitance was calculated from the integration of the 5th discharge curve. As shown in FIG. 1, the capacitance of Br-PAC was 47.3 F per g of active material.

### COMPARATIVE EXAMPLE 2

Another quantity of the same commercially available powdered activated carbon as used in Example 1 (PAC, 0.8 g) was mixed with binder (polyvinylidene fluoride; PVDF, 0.1 g)) and conductive carbon black (0.1 g) in N-methylpyrrolidinone (NMP). The resultant paste was coated on a alumina foil using a Doctor Blade available for example from MTI Corporation of Richmond, Calif., from which multiple coin cells of about 2 cm diameter were assembled with lithium foil as counter electrode and 1M Lithium hexafluorophosphate (LiPF₆) in EC/DMC (1:1 ratio) as electrolyte.

The cyclic voltammetry (CV) curves were measured with a potentiostat (model no. SP-150, Bio-Logic Science instruments SAS, Claix, France) at 10 mV/s scan rate and repeated 5 times, and the capacitance was calculated from the integration of the 5th discharge curve. As shown in FIG. 1, the capacitance of PAC was 31.4 F per g of active material.

As can be seen from the half-cell results depicted in FIG. 1, the electrode coated with gas-phase brominated powdered activated carbon had a surprisingly improved capacitance (47.3 F per gram of active material) over that of a similar electrode but coated with unbrominated powdered activated carbon (31.4 F per gram of active material).

### EXAMPLE 3

Another quantity of the same Br-PAC as in Example 1 was tested in a second lab. Similar results to that of Example 1 were achieved.

Br-PAC (0.8 g) was mixed with binder (polyvinylidene fluoride; PVDF, 0.1 g)) and conductive carbon black (0.1 g) in N-methylpyrrolidinone (NMP). The resultant paste was coated on a alumina foil using a Doctor Blade available for example from MTI Corporation of Richmond, Calif., from which multiple coin cells of about 2 cm diameter were assembled with lithium foil as counter electrode and 1M Lithium hexafluorophosphate (LiPF₆) in EC/DMC (1:1 ratio) as electrolyte.

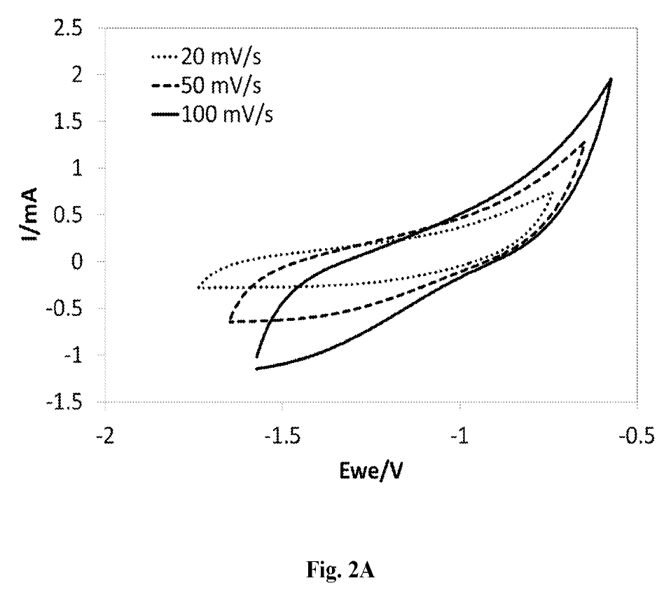

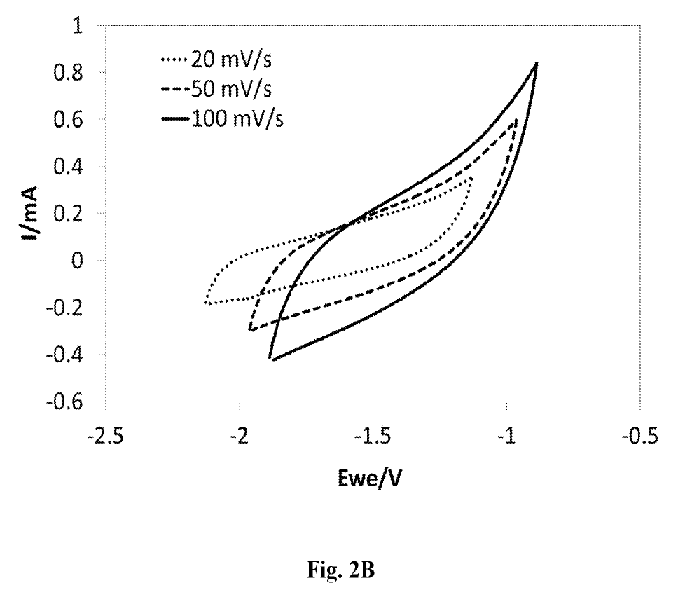

The cyclic voltammetry (CV) curves were measured with a potentiostat at different scan rate (20, 50, and 100 mV/s) and repeated 5 times, as shown in FIG. 2A, and the capacitance was calculated from the integration of the 5th discharge curve. At scan rate of 50 mV/s, the capacitance of Br-PAC was 45.3 F per g of active material.

### COMPARATIVE EXAMPLE 4

The same commercially available PAC as in Example 1 and Comparative Example 2 was tested in a second lab.

The commercially available powdered activated carbon (PAC, 0.8 g) was mixed with binder (polyvinylidene fluoride; PVDF, 0.1 g)) and conductive carbon black (0.1 g) in N-methylpyrrolidinone (NMP). The resultant paste was coated on an alumina foil using a Doctor Blade available for example from MTI Corporation, from which multiple coin cells of about 2 cm diameter were assembled with lithium foil as counter electrode and 1M Lithium hexafluorophosphate (LiPF₆) in EC/DMC (50/50) as electrolyte.

The cyclic voltammetry (CV) curves were measured with a potentiostat at different scan rate (20, 50, and 100 mV/s) and repeated 5 times, as shown in FIG. 2B, the capacitance was calculated from the integration of the 5th discharge curve. At scan rate of 50 mV/s, the capacitance of PAC was 22.7 F per g of active material.

### EXAMPLE 5

Natural graphite (Asbury Carbons, Asbury, N.J., 4 g), was contacted with 6 g of liquid bromine for 48 hours at room temperature. Excess liquid bromine was present to ensure the formation of stage-2 bromine-intercalated graphite. All of the stage-2 bromine-intercalated graphite was continuously fed during a period of 60 minutes into a drop tube reactor (5 cm diameter) that had been pre-purged with nitrogen, while the reactor was maintained at 900° C. Bromine vapor pressure was maintained in the drop reactor for 60 minutes while the temperature of the reactor was kept at 900° C. The solid material in the reactor was cooled with a nitrogen flow.

Some of the cooled solid material (3 g) was contacted with liquid bromine (4.5 g) for 16 hours at room temperature with excess liquid bromine present to ensure the formation of stage-2 bromine-intercalated graphite. Then all of this stage-2 bromine-intercalated graphite was continuously fed during 30 minutes into a drop tube reactor (5 cm diameter) that had been pre-purged with nitrogen. The reactor was maintained at 900° C. during the feeding of the stage-2 bromine-intercalated graphite. Bromine vapor pressure was maintained in the drop reactor for 30 minutes while the temperature of the reactor was kept at 900° C. The solid material in the reactor was cooled with a nitrogen flow.

Some of the cooled solid material just obtained (2 g) was contacted with liquid bromine (3 g) for 24 hours at room temperature with excess liquid bromine present to ensure the formation of stage-2 bromine-intercalated graphite. Then all of this stage-2 bromine-intercalated graphite was continuously fed during 20 minutes into a drop tube reactor (5 cm diameter) that had been pre-purged with nitrogen. The reactor was maintained at 900° C. during the feeding of the stage-2 bromine-intercalated graphite. Bromine vapor pressure was maintained in the drop reactor for 60 minutes while the temperature of the reactor was kept at 900° C. The solid material in the reactor was cooled with a nitrogen flow.

Part of the cooled solid material from the third set of intercalation and exfoliation steps (1 g) was mixed with 50 mL of NMP, sonicated, and then filtered to obtain brominated graphene nanoplatelets. The filter cake was vacuum dried at 130° C. for 12 hours. The resultant Br-GNP (0.8 g) was mixed with binder (polyvinylidene fluoride; PVDF, 0.1 g)) and conductive carbon black (0.1 g) in N-methylpyrrolidinone (NMP). The resultant paste was coated on a copper foil using a Doctor Blade available for example from MTI Corporation of Richmond, Calif., from which multiple coin cells of about 2 cm diameter were assembled with lithium foil as counter electrode and 1M Lithium hexafluorophosphate (LiPF₆) in EC/DMC (1:1 ratio) as electrolyte.

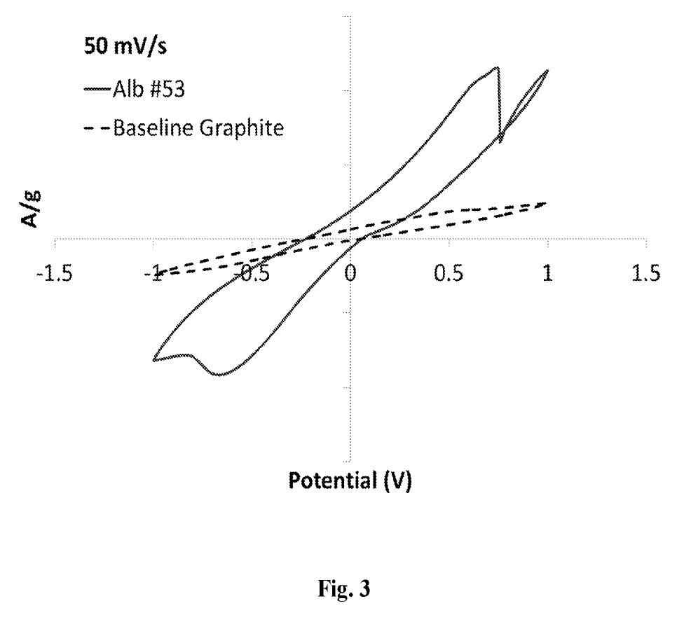

The cyclic voltammetry (CV) curves were measured with a potentiostat (model no. SP-150, Bio-Logic Science Instruments SAS, Claix, France) at 50 mV/s scan rate and repeated 10 times, and the capacitance was calculated from the integration of the 10th discharge curve. As shown in FIG. 3, the capacitance of Br-GNP (indicated as “Alb #53” on the figure's legend) was 109.7 F per g of active material.

### COMPARATIVE EXAMPLE 6

A commercially available graphite (0.8 g) was mixed with binder (polyvinylidene fluoride; PVDF, 0.1 g)) and conductive carbon black (0.1 g) in N-methylpyrrolidinone (NMP). The resultant paste was coated on a copper foil using a Doctor Blade available for example from MTI Corporation of Richmond, Calif., from which multiple coin cells of about 2 cm diameter were assembled with lithium foil as counter electrode and 1M Lithium hexafluorophosphate (LiPF6) in EC/DMC (1:1 ratio) as electrolyte.

The cyclic voltammetry (CV) curves were measured with a potentiostat (model no. SP-150, Bio-Logic Science Instruments SAS, Claix, France) at 50 mV/s scan rate and repeated 10 times, and the capacitance was calculated from the integration of the 10th discharge curve. As shown in FIG. 3, the capacitance of graphite (indicated as “Baseline Graphite” on the figure's legend) was 27.9 F per g of active material.

The results depicted in FIG. 3 indicated that half-cell electrode coated with brominated graphene nanoplatelets achieved surprisingly higher capacitance (109.7 F per gram of active material) as compared to a similar electrode coated with commercially available graphite (27.9 F per gram of active material).

### EXAMPLE 7

Prelithiation of graphite anode: the graphite coating as in Comparative Example 5 was held in 1M LiPF₆ in EC/DMC (1:1 ratio) electrolyte under 1.2 mA for 24 hours using a Li chip as a counter electrode and reference. The golden color was observed after this prelithiation treatment.

Multiple LIC coin cells of about 2 cm diameter, the prelithiated graphite as anode and Br-PAC as in Example 1 (Br-PACl) as cathode, were assembled with 1M Lithium hexafluorophosphate (LiPF₆) in EC/DMC (1:1 ratio) as electrolyte.

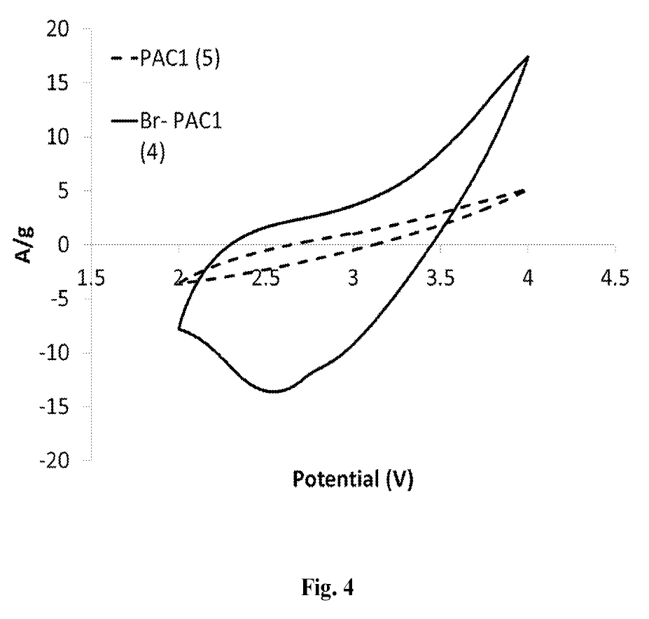

The initial voltages of the coin cells were measured with a voltmeter. The cyclic voltammetry (CV) curves were measured with a potentiostat at the scan rate of 100 mV/s for a 2 V window and repeated 10 times, as shown in FIG. 4, the capacitance was calculated from the integration of the 10th discharge curve. For Br-PACl at a scan rate of 100 mV/s, the capacitance was 89.4 F per g of active material.

### COMPARATIVE EXAMPLE 8

Multiple LIC coin cells of about 2 cm diameter, the same prelithiated graphite as in Example 7 as anode and powdered activated carbon as in Comparative Example 2 (PACl) as cathode, were assembled with 1M Lithium hexafluorophosphate (LiPF6) in EC/DMC (1:1 ratio) as electrolyte.

The initial voltages of the coin cells were measured with a voltmeter. The cyclic voltammetry (CV) curves were measured with a potentiostat at the scan rate of 100 mV/s for a 2 V window and repeated 10 times, as shown in FIG. 4, and the capacitance was calculated from the integration of the 10th discharge curve. For PACl at scan rate of 100 mV/s, the capacitance was 19.8 F per g of active material.

The results depicted in FIG. 4 illustrate the surprisingly superior capacitance of a lithium ion capacitor cell with a cathode coated with brominated powdered activated carbon (89.4 F per gram of active material), as compared to a similar cell with a cathode coated with unbrominated powdered activated carbon (19.8 F per gram of active material).

### EXAMPLE 9

A commercially available PAC of surface area about 800 m²/g was pre-dried at 120° C. and then exposed to gas-phase bromine of a predetermined amount according to the method of U.S. Pat. No. 6,953,494 to about 5.5 wt % bromine, the resultant Br-PACl (0.8 g) was mixed with binder (polyvinylidene fluoride; PVDF, 0.1 g)) and conductive carbon black (0.1 g) in N-methylpyrrolidinone (NMP). The resultant paste was coated on a copper foil using a Doctor Blade available for example from MTI Corporation of Richmond, Calif., from which symmetric coin cells of about 2 cm diameter were assembled and 2M lithium bis-(trifluoromethylsulfonyl)imide (LiTFSI) in EC/DMC (1:1 ratio) as electrolyte.

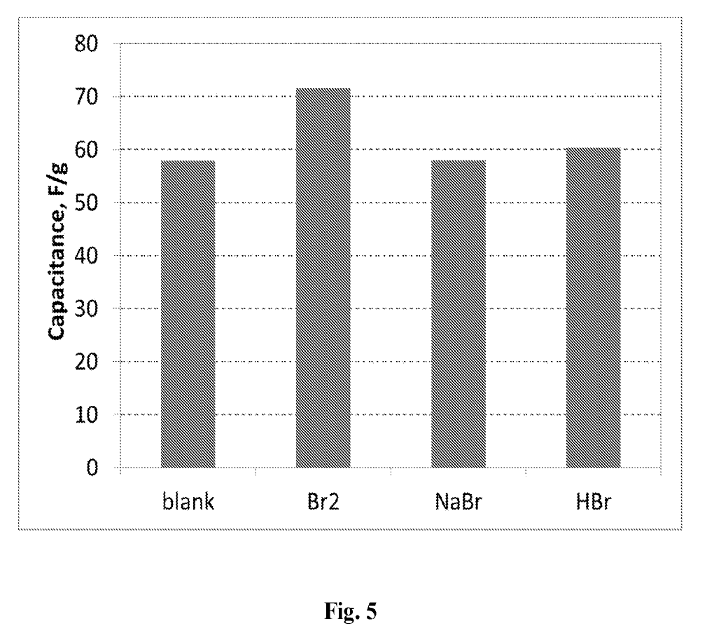

The cyclic voltammetry (CV) curves were measured with a potentiostat (model no. SP-150, Bio-Logic Science Instruments SAS, Claix, France) at 20 mV/s scan rate with 0˜2.5V voltage window and repeated 100 times, and the capacitance was calculated from the integration of the 100th discharge curve. As shown in FIG. 5, the capacitance of Br-PAC was 71.5 F per g of active material.

### EXAMPLE 9A

The same commercially available PAC used as a starting ingredient in Example 9 was pre-dried at 120° C. and then placed into respective beakers. The NaBr or HBr solution, respectively, of predetermined amount was added into the respective beaker drop by drop while the PAC was thoroughly stirred, then dried at 120° C. for 12 hours. The resultant brominated PACs, brominated with NaBr solution or HBr solution, respectively, each contained about 5.5 wt. % bromine. In each case, part of the resultant brominated carbon (0.8 was mixed with binder (polyvinylidene fluoride; PVDF, 0.1 g) and conductive carbon black (0.1 g) in N-methylpyrrolidinone (NMP). In each case, the resultant paste was coated on a copper foil using a Doctor Blade available for example from MTI Corporation of Richmond, Calif., from which symmetric coin cells of about 2 cm diameter were assembled and 2M lithium bis-(trifluoromethylsulfonyl)imide (LiTFSI) in EC/DMC (1:1 ratio) as electrolyte.

The cyclic voltammetry (CV) curves were measured with a potentiostat (model no. SP-150, Bio-Logic Science Instruments SAS, Claix, France) at 20 mV/s scan rate with 0˜2.5V voltage window and repeated 100 times, and the capacitance was calculated from the integration of the 100th discharge curve. As shown in FIG. 5, the capacitance of the blank PAC was 57.9 F per g of active material, the capacitance of the PAC treated with NaBr was 57.9 F per g of active material, and the capacitance of the sample with HBr was 60.3 per g of active material.

### EXAMPLE 10

The same commercially available PAC used as a starting ingredient in Examples 9 and 9A was treated with HCl solution to about 1.8 wt % chlorine, and the resultant chlorinated carbon (0.8 g) was mixed with binder (polyvinylidene fluoride; PVDF, 0.1 g)) and conductive carbon black (0.1 g) in N-methylpyrrolidinone (NMP). The resultant paste was coated on a copper foil using a Doctor Blade available for example from MTI Corporation of Richmond, Calif., from which symmetric coin cells of about 2 cm diameter were assembled and 2M lithium bis-(trifluoromethylsulfonyl)imide (LiTFSI) in EC/DMC (1:1 ratio) as electrolyte.

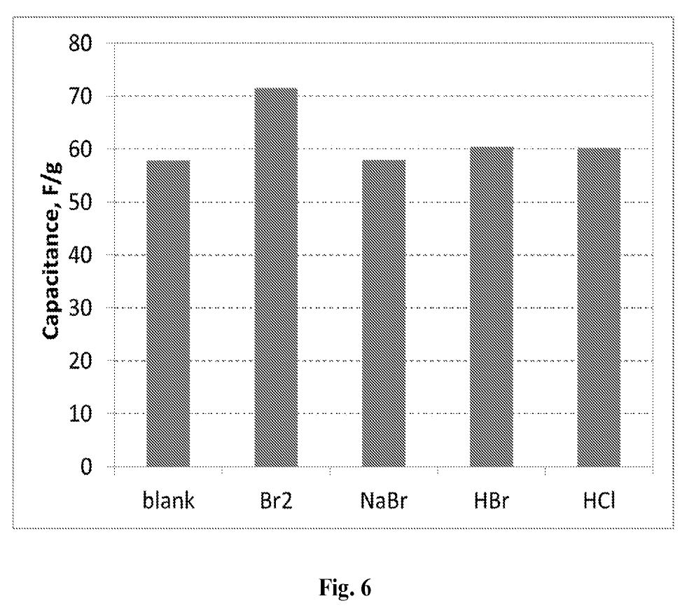

The cyclic voltammetry (CV) curves were measured with a potentiostat (model no. SP-150, Bio-Logic Science Instruments SAS, Claix, France) at 20 mV/s scan rate with 0˜2.5V voltage window and repeated 100 times, and the capacitance was calculated from the integration of the 100th discharge curve. As shown in FIG. 6, the capacitance of the sample with HCl was 60.2 F per g of active material.

As may be seen from the electrochemical testing results in Examples 9, 9A and 10, gas-phase brominated powdered activated carbon using bromine provided surprisingly superior capacitance as compared to electrodes coated with unbrominated PAC or coated with brominated or chlorinated PACs halogenated by other means.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. An energy storage device comprising:
a cathode comprised of one or more layers that are comprised of a halogenated activated carbon,
an anode comprised of one or more layers that are comprised of a halogenated graphene, and
a lithium ion source.

2. The device of claim 1, further comprising at least one conductive medium disposed between the cathode and the anode.

3. The device of claim 2, further comprising a separator disposed between the cathode and the anode.

4. The device of claim 1, wherein the halogenated activated carbon is a gas-phase brominated activated carbon.

5. The device of claim 4, wherein the halogenated graphene comprises a brominated graphene.

6. The device of claim 5, wherein the brominated graphene is comprised of brominated graphene nanoplatelets.

7. The device of claim 6, wherein the brominated graphene nanoplatelets comprise one or more graphene layers and are characterized by being, except for the carbon atoms forming the perimeters of the graphene layers of the nanoplatelets, (i) free from any element or component other than sp2 carbon, and (ii) substantially defect-free graphene layers, wherein the total content of halogen in the nanoplatelets is about 5 wt % or less calculated as bromine and based on the total weight of the nanoplatelets.

8. The device of claim 1, wherein the halogenated graphene comprises a brominated graphene.

9. The device of claim 8, wherein the brominated graphene is comprised of brominated graphene nanoplatelets.

10. The device of claim 9, wherein the brominated graphene nanoplatelets comprise one or more graphene layers and are characterized by being, except for the carbon atoms forming the perimeters of the graphene layers of the nanoplatelets, (i) free from any element or component other than sp2 carbon, and (ii) substantially defect-free graphene layers, wherein the total content of halogen in the nanoplatelets is about 5 wt % or less calculated as bromine and based on the total weight of the nanoplatelets.

11. A process for forming a cathode for use in an energy storage device, the process comprising:
forming the cathode so as to provide at least one cathode surface layer, the cathode surface layer being comprised of a gas-phase brominated activated carbon.

12. The process of claim 11, wherein the amount of bromine in the gas-phase brominated activated carbon is in the range of about 0.1 wt. % to about 15 wt. %, based on the weight of the total brominated activated carbon.

13. A process for producing an energy storage device, the process comprising
carrying out the process according to claim 11,
forming an anode so as to provide at least one anode surface layer, the anode surface layer being comprised of a halogenated graphene,
providing a lithium ion source either in or adjacent to the anode, and
disposing the anode and the cathode adjacent one another with a conductive medium there between.

14. The process according to claim 13, wherein the halogenated graphene comprises a brominated graphene.

15. The process according to claim 4, wherein the brominated graphene is comprised of brominated graphene nanoplatelets.

16. The process of claim 15, wherein the brominated graphene nanoplatelets comprise one or more graphene layers and are characterized by being, except for the carbon atoms forming the perimeters of the graphene layers of the nanoplatelets, (i) free from any element or component other than sp2 carbon, and (ii) substantially defect-free graphene layers, wherein the total content of halogen in the nanoplatelets is about 5 wt % or less calculated as bromine and based on the total weight of the nanoplatelets.

17. An energy storage device comprising a first electrode, a second electrode, a lithium ion source and a conductive medium disposed between the first and the second electrodes, one of the electrodes being comprised of at least one surface layer, wherein the surface layer is comprised of a gas-phase brominated activated carbon.

18. The device of claim 17, wherein the amount of bromine in the gas-phase brominated activated carbon is in the range of about 0.1 to about 15 wt. %, based on the weight of the total brominated activated carbon.
